(19) United States
(12) Patent Application Publication
(10) Pub. No.: US 2009/0164982 A1
(43) Pub. Date: Jun. 25, 2009

(54) METHOD AND SYSTEM FOR TRANSFORMING BINARIES TO USE DIFFERENT INSTRUCTIONS

(75) Inventors: Sheldon Lobo, Cary, NC (US); Fu-Hwa Wang, Saratoga, CA (US)

Correspondence Address: OSHA LIANG L.L.P./SUN, TWO HOUSTON CENTER, 909 FANNIN, SUITE 3500, HOUSTON, TX, 77010, US

(73) Assignee: SUN MICROSYSTEMS, INC., Santa Clara, CA (US)

(21) Appl. No.: 11/962,962

(22) Filed: Dec. 21, 2007

(51) Int. Cl. G06F 9/44

(52) U.S. Cl. 717/138

(57) ABSTRACT

In general, in one aspect, the invention relates to a method for transforming binaries to use different instructions. The method includes identifying an instruction in the binary, where the instruction is an unimplemented instruction of an instruction set of a processor. The method further includes replacing the instruction with emulation code, where execution of the emulation code emulates execution of the instruction, and generating an updated binary including the emulation code.

### BACKGROUND

Typically, source code is compiled to a binary that executes using a particular instruction set. Further, the source code may need to be compiled multiple times to generate binaries compatible with multiple instruction sets. For example, source code may need to be compiled separately to generate a binary that executes with a SPARC instruction set and a binary that executes with an x86 instruction set.

The instruction set of processor families may include many of the same instructions. However, in some cases, specialized instructions may be specific to a particular processor of a processor family. For example, the instruction set of the UltraSPARC T1 processor, a member of the SPARC family of processors available from Sun Microsystems, Inc., includes specialized quad-precision floating point instructions not available in the instruction sets of other SPARC processors. To take advantage of the specialized quad-precision floating point instructions, a compiler may generate a binary that is optimized for the UltraSPARC T1 processor. This binary may not be successfully executed on another SPARC processor with an instruction set that does not include support for the specialized quad-precision floating point instructions.

If a binary contains an unimplemented instruction of an instruction set, it is possible to alter and recompile the original source code to generate a new binary that can be executed with the instruction set. Alternatively, the unsupported instruction may be supported through emulation. In this latter instance, when the unsupported instruction is encountered during execution, a system-level trap is triggered that transfers execution to a trap handler. The trap handler then executes emulation code that is equivalent to the unimplemented instruction. Typically, the use of system level traps incurs a slight performance penalty due to the overhead of instruction lookup and control transfer to the emulation code.

### SUMMARY

In general, in one aspect, the invention relates to a method for transforming binaries to use different instructions. The method includes identifying an instruction in the binary, wherein the instruction is an unimplemented instruction of an instruction set of a processor. The method further includes replacing the instruction with emulation code, wherein execution of the emulation code emulates execution of the instruction, and generating an updated binary including the emulation code.

In general, in one aspect, the invention relates to a computer system including a processor, a memory, and instructions stored in memory. The instructions are for causing the computer system to identify an instruction in the binary, wherein the instruction is an unimplemented instruction of an instruction set of a target processor. The instructions are further for causing the computer system to replace the instruction with emulation code, wherein execution of the emulation code emulates execution of the instruction, and to generate an updated binary including the emulation code.

In general, in one aspect, the invention relates to a computer readable medium embodying instructions executable by a computer to perform method steps for transforming binaries to use different instructions, the instructions including functionality to identify an instruction in the binary, wherein the instruction is an unimplemented instruction of an instruction set of a processor. The instructions further include functionality to replace the instruction with emulation code, wherein execution of the emulation code emulates execution of the instruction, and to generate an updated binary including the emulation code.

Other aspects and advantages of the invention will be apparent from the following description and the appended claims.

### BRIEF DESCRIPTION OF DRAWINGS

FIGS. 1-3 show systems in accordance with one or more embodiments of the invention.

FIGS. 4-8 show flowcharts of a method in accordance with one or more embodiments of the invention.

FIGS. 9 and 10 show examples in accordance with one or more embodiments of the invention.

FIG. 11 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method and system for transforming binaries. Specifically, embodiments of the invention replace identified instruction(s) of an original binary with emulation code to generate an updated binary that includes the emulation code instead of the identified instruction(s). In one or more embodiments of the invention, the emulation code is inserted inline in the updated binary in place of one or more identified instructions such that the emulation code may be executed without transferring control to a trap handler. Further, in one or more embodiments of the invention, the identified instruction(s) of the original binary are replaced without requiring access to the source code of the original binary. In addition, in one or more embodiments of the invention, the emulation code may be a trap instruction configured to transfer control of the execution to instructions specified by a user.

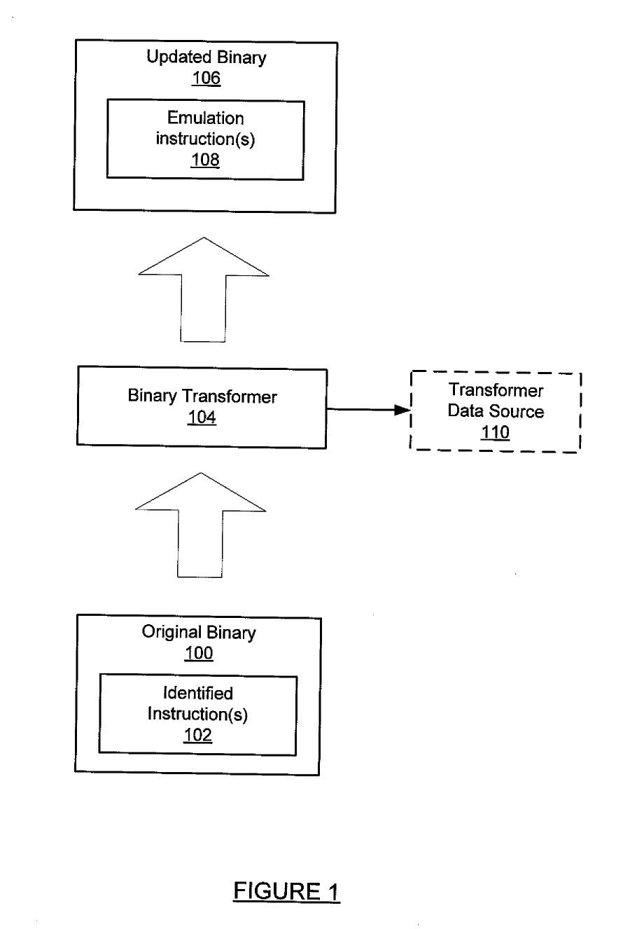

FIG. 1 shows a system in accordance with one or more embodiments of the invention. More specifically, FIG. 1 shows a binary transformer (104) interacting with an original binary (100) and an updated binary (106). The original binary (100) may be generated by a compiler (not shown). More specifically, the compiler compiles source code to generate the original binary (100) including a number of instructions. In one or more embodiments of the invention, the instructions are of a lower level computer language (e.g., assembly language, machine language, etc.). Further, the instructions may be included in an instruction set associated with a processor (not shown). In one or more embodiments of the invention, the compiler is configured to generate binaries optimized for the instruction set. For example, the compiler may be configured to use specialized instructions provided by the instruction set.

The original binary (100) may include identified instruction(s) (102). In one of more embodiments of the invention, the identified instruction(s) (102) may be identified by the binary transformer (104). More specifically, the binary transformer (104) may be configured to identify instructions based on input from a user. In some embodiments of the invention, the binary transformer (104) is configured to identify instructions automatically based on certain conditions. For example, the binary transformer (104) may be configured to identify unimplemented instructions in an instruction set of a target processor (i.e., the instruction set of a processor that will execute the updated binary (106)).

In another example, the binary transformer (104) may be configured to identify deprecated instructions in an instruction set. A deprecated instruction is an instruction that is included in an instruction set a new processor in a processor family to provide backward compatibility with an instruction set of an earlier developed processor in that family of processors. The instruction may be deprecated because, for example, the new instruction set includes a new more efficient instruction that replaces the old instruction. In this case, the deprecated instruction may still be implemented in the new instruction set to provide support for legacy binaries.

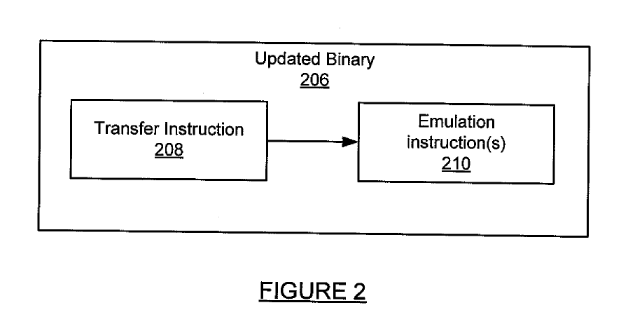

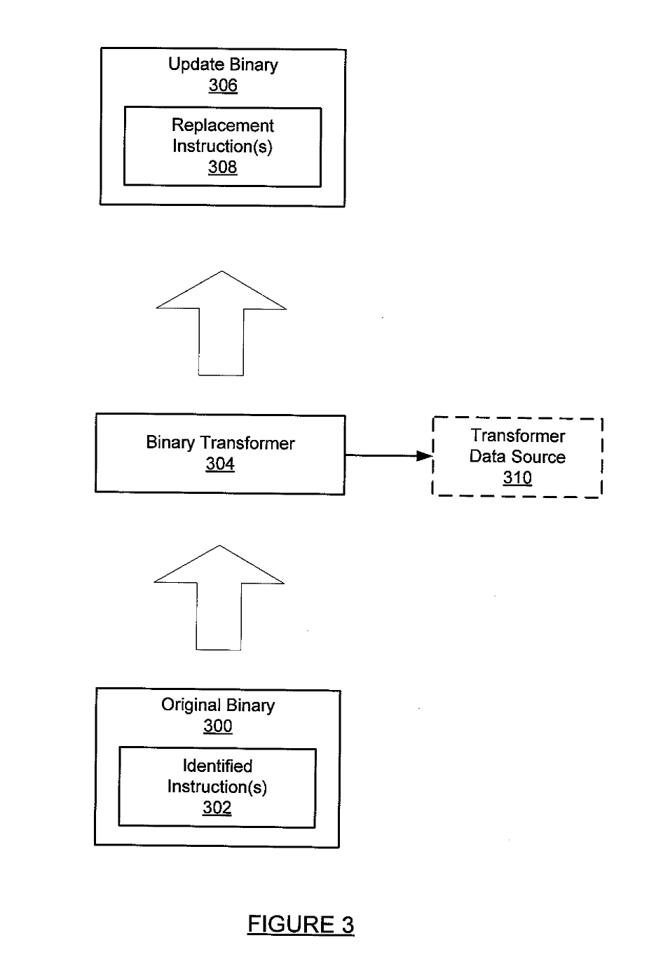

In one or more embodiments of the invention, the binary transformer (104) is farther configured to replace instruction(s) in the original binary (100). More specifically, the binary transformer (104) is configured to replace identified instruction(s) (102) in the original binary (100) with emulation code. In one or more embodiments of the invention, emulation code includes, but is not limited to, emulation instruction(s) (102) for inline expansion, a transfer instruction to a routine, or a software trap instruction. Emulation code including a transfer instruction to a routine is discussed in more detail in reference to FIG. 2. Emulation code that is a software trap instruction is discussed in more detail in reference to FIG. 3.

In one or more embodiments of the invention, the emulation code may provide the same result as instructions executed by a trap handler in response to encountering an unimplemented instruction. For example, when an unimplemented instruction is encountered during execution of the original binary (100), control may be transferred to a trap handler (not shown) configured to execute instructions that emulate the unimplemented instruction. Further, those skilled in the art will appreciate that emulation code may include a number of emulation instruction(s) (108). In addition, in some embodiments of the invention, the emulation code is specified by a user of the binary transformer (104). For example, the user may store emulation code associated with an unimplemented instruction in the transformer data source (110) or provide the emulation code as a parameter when invoking the binary transformer (104).

In one or more embodiments of the invention, the binary transformer (104) is configured to generate an updated binary (106) including the emulation code. The emulation code includes emulation instruction(s) (108) that emulate an unimplemented instruction of the original binary (100). In one or more embodiments of the invention, the binary transformer (104) retrieves the emulation instruction(s) (108) from a transformer data source (110) that stores emulation instruction(s) (108) associated with unimplemented instruction(s).

In one or more embodiments of the invention, the transformer data source (110) is a repository storing the emulation code (e.g., a database, a file system, one or more data structures configured in a memory, an extensible markup language (XML) file, some other medium for storing data, or any suitable combination thereof) which includes information (e.g., emulation instruction(s), replacement instruction, etc.) related to the identified instruction(s) (102). Further, the transformer data source (110) may be configured to include different versions of emulation code for each unimplemented instruction, where each of the versions is related to a particular instruction set. In this case, the binary transformer (104) may be configured to generate updated binaries (106) for particular instruction sets using the different versions of the emulation code.

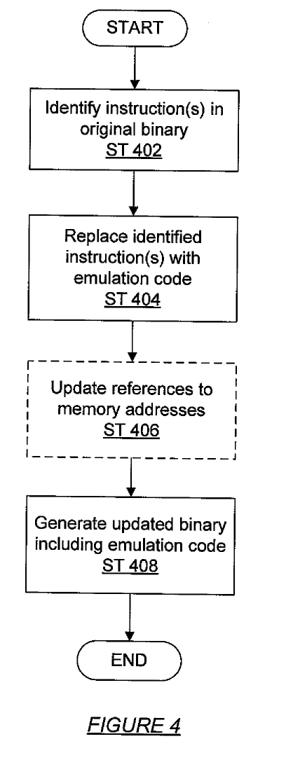

In one or more embodiments of the invention, the emulation instruction(s) (108) are configured to be executed in the updated binary (106). More specifically, in one or more embodiments of the invention, the emulation instruction(s) (108) are implemented in the updated binary (106) such that the emulation instruction(s) (108) are executed without using a trap handler. Further, in one or more embodiments of the invention, the emulation instruction(s) (108) replace each occurrence of the identified instruction(s) in the updated binary (106) (i.e., are placed inline in the binary). As is explained in more detail below in reference to FIG. 4, in such embodiments, references to memory addresses of instructions in the binary may be updated as a result of adding the emulation instruction(s) (108).

FIG. 2 shows a system in accordance with one or more embodiments of the invention. More specifically, FIG. 2 shows an updated binary (206) generated by a binary transformer (104 of FIG. 1). As shown in FIG. 2, the updated binary (206) includes emulation code that includes a transfer instruction (208) and emulation instructions (108).

In one or more embodiments of the invention, the binary transformer (104 of FIG. 1) is configured to add the emulation instruction(s) (210) to the updated binary (206). More specifically, the binary transformer (104 of FIG. 1) may be configured to create a routine (e.g., a sequence of instructions that is accessible by branch or jump instruction and returns control the next instruction after the calling branch or jump instruction after execution) in the updated binary (206) that includes the emulation instruction(s) (210). Those skilled in the art will appreciate that a routine may be defined in the updated binary (206) such that the routine may be called from multiple locations in the updated binary (206).

In one or more embodiments of the invention, the emulation instruction(s) (210) may be instructions that provide the same result as instructions executed by a trap handler in response to encountering an unimplemented instruction. In some embodiments of the invention, the emulation instruction(s) are provided through an application programming interface (API) of an operating system associated with the trap handler. In some embodiments, the emulation instruction(s) (210) may be obtained from a transformer data source (110 of FIG. 1). Further, in some embodiments, a user may provide the emulation instruction(s) (210) using an API.

In one or more embodiments of the invention, the binary transformer (104 of FIG. 1) is configured to replace an identified instruction (102 of FIG. 1) with a transfer instruction (208). The transfer instruction may transfer execution of the updated binary (206) to a routine including the emulation instruction(s) (210). Those skilled in the art will appreciate that a number of identified instruction(s) (102 of FIG. 1) may each be replaced with a transfer instruction (208). In this case, each transfer instruction (208) may transfer execution of the updated binary (206) to the same routine (108).

FIG. 3 shows a system in accordance with one or more embodiments of the invention. More specifically, FIG. 3 shows a binary transformer (304) interacting with an original binary (300) and an updated binary (306). The original binary (300) may be generated by a compiler (not shown). More specifically, the compiler compiles source code to generate the original binary (300) including a number of instructions. In one or more embodiments of the invention, the instructions are of a lower level computer language (e.g., assembly language, machine language, etc.). Further, the instructions may be included in an instruction set associated with a processor (not shown). In one or more embodiments of the invention, the compiler may be configured to generate binaries optimized for the instruction set. For example, the compiler may be configured to use specialized instructions provided by the instruction set.

The original binary (300) may include identified instruction(s) (302). In one of more embodiments of the invention, the identified instruction(s) (302) may be identified by the binary transformer (304). More specifically, the binary transformer (304) may be configured to identify instructions based on input from a user. In some embodiments of the invention, the binary transformer (304) is configured to identify instructions automatically based on certain conditions. For example, the binary transformer (304) may be configured to identify unimplemented instructions in an instruction set of a target processor. In another example, the binary transformer (304) may be configured to identify deprecated instructions in the instruction set.

In one or more embodiments of the invention, the binary transformer (304) is configured to replace instruction(s) of the original binary (300). More specifically, the binary transformer (304) is configured to replace identified instruction(s) (302) in the original binary (300). For example, the binary transformer (304) may replace identified instruction(s) (302) at a specific memory address with replacement instruction(s) (308). In one or more embodiments of the invention, the replacement instruction(s) (308) is obtained from a transformer data source (310) based on the deprecated instruction.

In one or more embodiments of the invention, the transformer data source (310) is a data store (e.g., a database, a file system, one or more data structures configured in a memory, an extensible markup language (XML) file, some other medium for storing data, or any suitable combination thereof), which may include information (e.g., replacement instruction, instruction set information, etc.) related to the identified instruction(s) (302).

In one or more embodiments of the invention, the binary transformer (304) is configured to generate an updated binary (306) including the replacement instruction(s) (308). The replacement instruction(s) (308) may be configured to provide the same result as the identified instruction(s) (302) when executed.

FIG. 4 shows a flowchart of a method for transforming a binary in accordance with one or more embodiments of the invention. In some embodiments of the invention, one or more of the steps shown in FIG. 4 may be omitted, repeated, performed concurrently, and/or performed in a different order than that shown in FIG. 4. Accordingly, the specific arrangement of steps shown in FIG. 4 should not be construed as limiting the scope of the invention.

Initially, instruction(s) of an original binary may be identified (ST 402). In one or more embodiments of the invention, the instruction(s) may be identified based on input from a user. For example, the user may specify that all occurrences of a particular instruction be identified. In some embodiments of the invention, the instructions may be identified automatically based on a condition. For example, the condition may specify that all unimplemented instructions in the original binary be identified. Those skilled in the art will appreciate that multiple instructions may be identified together as a set of instructions, which can be collectively replaced.

The identified instruction(s) are then replaced with emulation code (ST 404). The emulation code may include emulation instruction(s) associated with the identified instruction(s) in the original binary. The emulation instruction(s) may be configured to provide the same result as instructions executed by a trap handler when the identified instruction is encountered. In some embodiments of the invention, the emulation instruction(s) may be obtained using an Application Programming Interface (API) of an operating system associated with the trap handler. In another example, the emulation instruction(s) may be obtained from a data source based on the identified instruction. Methods for replacing the identified instructions with emulation code are discussed in more detail below in reference to FIGS. 5-7.

Optionally, references to memory addresses of instructions in the binary may be updated (ST 406). In one or more embodiments of the invention, the emulation code may include a different number of instructions than the identified instruction(s). In such embodiments, the references to the memory addresses are updated in response to replacing the identified instruction(s) with the emulation code. For example, when replacing a single identified instruction with emulation code including two instructions, all references to memory addresses occurring after the emulation code are changed to compensate for the additional instruction. Those skilled in the art will appreciate that the original binary may be compiled to include information configured to assist in the updating of the memory address references. For example, the original binary may be compiled to include information identifying the memory address references that should be updated when the memory addresses of instructions are shifted.

Next, an updated binary including the emulation code is generated (ST 408). In one or more embodiments of the invention, the updated binary is configured to execute using an instruction set for a processor. For example, the updated binary may include emulation code for an unimplemented instruction of the instruction set. Further, the updated binary is configured to execute the emulation code without requiring the use of a trap handler.

FIGS. 5-7 show flow charts for replacing identified instruction(s) as described in ST 404 of FIG. 4 in accordance with one or more embodiments of the invention. In some embodiments of the invention, one or more of the steps shown in FIGS. 5-7 may be omitted, repeated, performed concurrently, and/or performed in a different order than that shown in FIGS. 5-7. Accordingly, the specific arrangement of steps shown in FIGS. 5-7 should not be construed as limiting the scope of the invention.

As shown in FIG. 5, initially, emulation instruction(s) are obtained (ST 502). In one or more embodiments of the invention, the emulation instruction(s) may be obtained from a data source based on the identified instruction(s). In such embodiments, the emulation instruction(s) may provide the same result as instructions executed by a trap handler triggered in response to encountering an unimplemented instruction in the original binary. In one or more embodiments of the invention, the emulation instruction(s) are obtained using an Application Programming Interface (API) of an operating system associated with the trap handler. In addition, in some embodiments of the invention, the emulation instruction(s) may be obtained from the trap handler for the unimplemented instruction.

Next, the unimplemented instruction(s) are replaced with the emulation instruction(s) (ST 504). In one or more embodiments of the invention, the locations for the identified instruction(s) in the binary may be overwritten with the emulation instruction(s). If the number of emulation instruction(s) exceeds the number of identified instructions, the additional emulation instruction(s) are inserted in the binary (i.e., inline expansion) and memory address references to instructions occurring after the memory address of the identified instruction(s) may be changed to compensate for the inserted emulation instruction(s). In one or more embodiments of the invention, the original binary contains multiple occurrences of the identified instruction(s). Each of the occurrences of the identified instructions may be replaced with the emulation instruction(s).

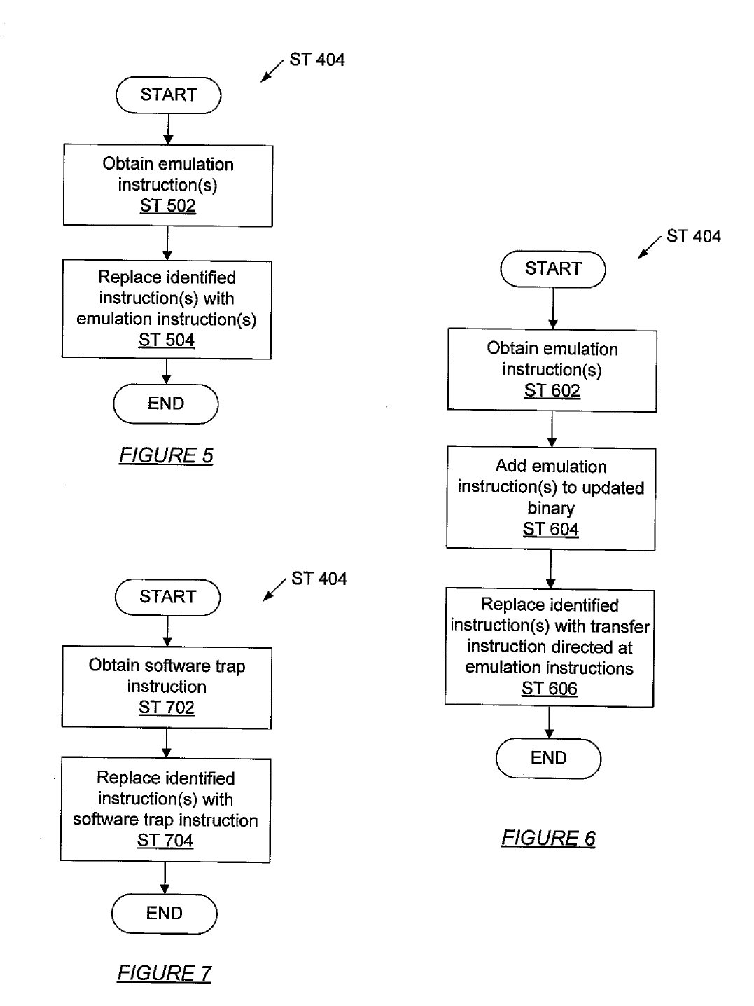

As shown in FIG. 6, initially, emulation instruction(s) are obtained (ST 602). In one or more embodiments of the invention, the emulation instruction(s) may be obtained from a data source based on the identified instruction(s). In such embodiments, the emulation instruction(s) may provide the same result as instructions executed by a trap handler triggered in response to encountering an unimplemented instruction in the original binary. In one or more embodiments of the invention, the emulation instruction(s) are obtained using an Application Programming Interface (API) of an operating system associated with the trap handler. In addition, in some embodiments of the invention, the emulation instruction(s) may be obtained from a data source.

In ST 604, the emulation instruction(s) are added to an updated binary. In one or more embodiments of the invention, the emulation instruction(s) may be added as a routine in the updated binary. In this case, the routine may be executed by transferring execution of the binary to the routine. Those skilled in the art will appreciate that the emulation instruction(s) may be added to the updated binary such that the memory addresses of existing instructions are not affected (e.g., the emulation instructions may be added to the end of the binary).

Next, the identified instruction(s) are replaced with a transfer instruction to the emulation instruction(s) (ST 606). More specifically, the identified instruction(s) may be replaced with a transfer instruction (e.g., call instruction, branch instruction, etc.) to the routine containing the emulation instruction(s). In one or more embodiments of the invention, the original binary contains multiple occurrences of the identified instruction(s). Each of the occurrences of the identified instruction(s) may be replaced with a transfer instruction to the same routine. In this case, the use of a routine may minimize the size of the updated binary since only a single copy of the emulation instruction(s) is included in the updated binary.

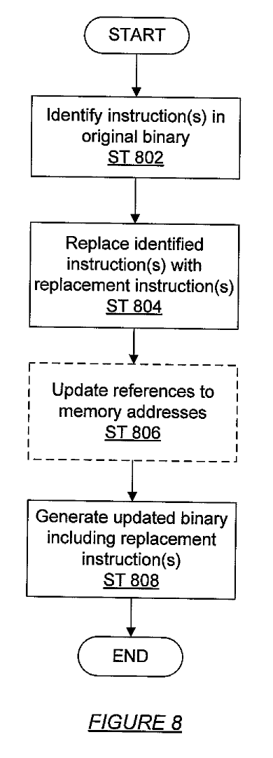

As shown in FIG. 7, initially, a software trap instruction may be obtained (ST 702). The software trap instruction may transfer execution of the updated binary to emulation instruction(s) specified by a user. For example, the software trap instruction may transfer execution to a user application including a user specified trap handler for executing emulation instruction(s). In one or more embodiments of the invention, the software trap instruction may be obtained from a data source based on the identified instruction(s).

Next, the identified instruction(s) may be replaced with the software trap instruction (ST 704). More specifically, the location of the identified instruction(s) in the binary may be overwritten with the software trap instruction. In one or more embodiments of the invention, the original binary contains multiple occurrences of the identified instruction(s). Each of the occurrences of the identified instructions may be replaced with a software trap instruction.

FIG. 8 shows a flowchart of a method for transforming a binary in accordance with one or more embodiments of the invention. In some embodiments of the invention, one or more of the steps shown in FIG. 8 may be omitted, repeated, performed concurrently, and/or performed in a different order than that shown in FIG. 8. Accordingly, the specific arrangement of steps shown in FIG. 8 should not be construed as limiting the scope of the invention.

Initially, instruction(s) of an original binary are identified (ST 802). In one or more embodiments of the invention, the instruction(s) may be identified based on input from a user. For example, the user may specify that all occurrences of a particular instruction be identified. Alternatively, the instructions may be identified automatically based on a specified condition. For example, the condition may specify that all deprecated instructions of an instruction set be identified in the original binary. A deprecated instruction may be an instruction that is considered to be obsolete. In one or more embodiments of the invention, the deprecated instruction may be an instruction that has been replaced in the instruction set with a replacement instruction. In addition, in some embodiments of the invention, the deprecated instruction is an instruction that is not actively supported by the instruction set.

At ST 804, the identified instruction(s) in the original binary is replaced with replacement instruction(s). In some embodiments of the invention, the replacement instruction(s) may be a newer implementation of a deprecated instruction in an instruction set. For example, an instruction set may include a deprecated floating add instruction as well as a newer floating add instruction.

Optionally, references to memory addresses of instructions may be updated (ST 806). In one or more embodiments of the invention, the replacement instruction(s) may include a different number of instructions than the identified instruction(s). In such embodiments, the references to the memory addresses may be updated in response to replacing the identified instruction(s) with the replacement instruction(s). For example, when replacing a single identified instruction with replacement instruction(s) including two instructions, all references to memory addresses occurring after the replacement instruction(s) may be changed to compensate for the additional instruction.

Next, an updated binary including the replacement instruction(s) is generated (ST 808). In one or more embodiments of the invention, the updated binary includes replacement instruction(s) in place of the identified deprecated instruction(s) of the instruction set.

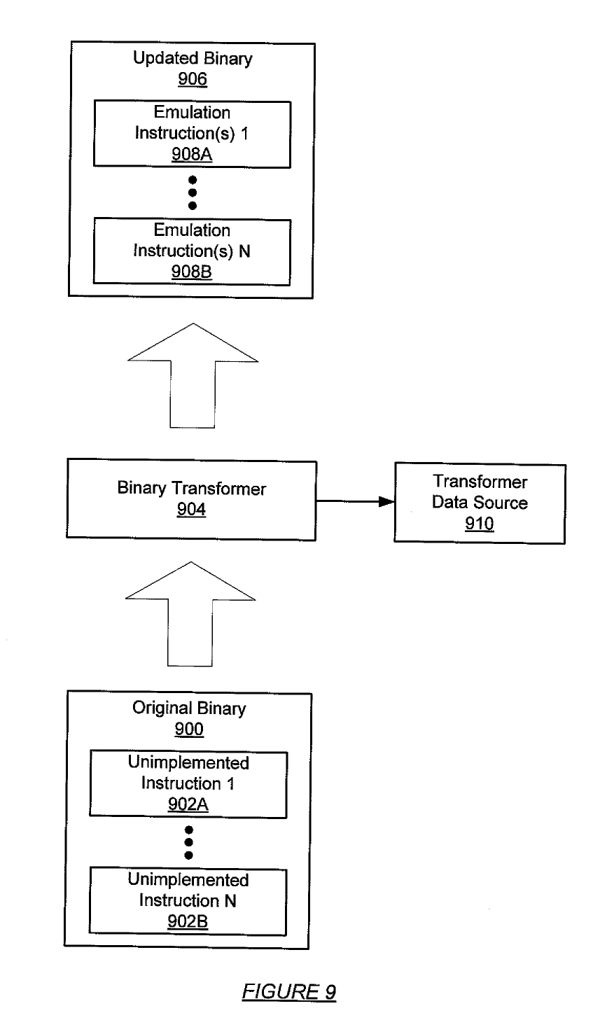

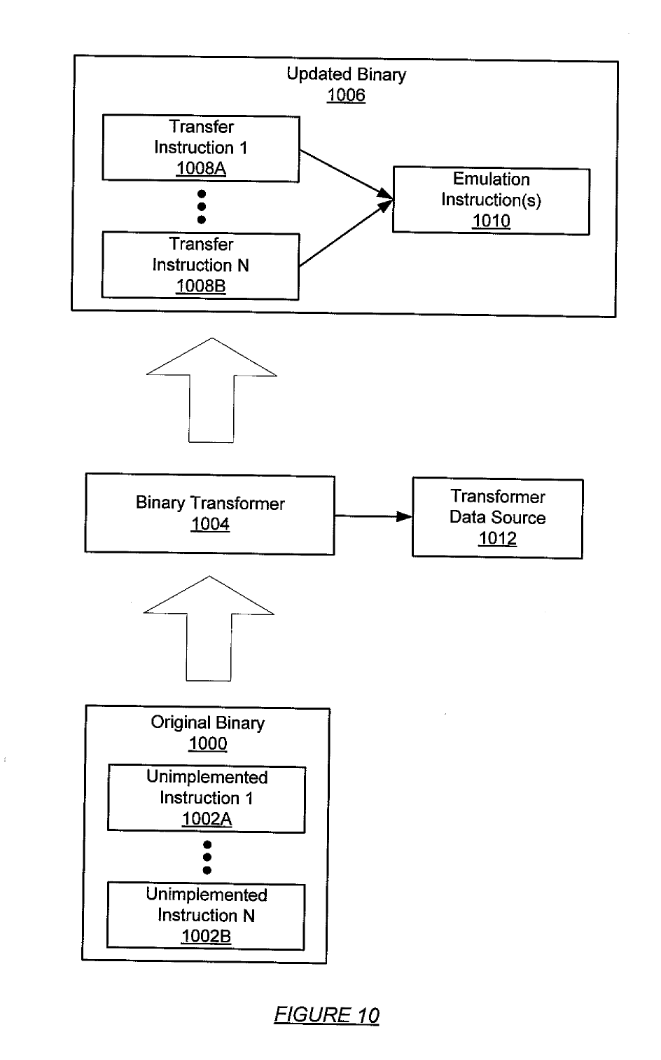

FIG. 9 shows an example of replacing identified instruction(s) with emulation code in accordance with one or more embodiments of the invention. In the example of FIG. 9, the identified instruction(s) are replaced with emulation instruction(s).

The original binary (900) is generated by a compiler (not shown) from source code. The original binary (900) includes a number of unimplemented instruction(s), unimplemented instruction 1 (902A) through unimplemented instruction N (902B). These unimplemented instructions may be located anywhere in the original binary (900). The binary transformer (904) identifies unimplemented instruction 1 (902A) through unimplemented instruction N (902B) based on input from a user. For example, the user specifies that all unimplemented instructions in an instruction set are to be identified in the original binary (900).

Next, the binary transformer (904) replaces each of unimplemented instruction 1 (902A) through unimplemented instruction N (902B) with emulation instruction(s) (908A) through emulation instruction(s) N (908B) to generate an updated binary (906). More specifically, the binary transformer (904) replaces unimplemented instruction 1 (902A) with emulation instruction(s) 1 (908A) and unimplemented instruction N (902B) with emulation instruction(s) N (908B). The emulation instruction(s) (908) are obtained from a transformer data source (910). The transformer data source (910) includes emulation instruction(s) for each unimplemented instruction of the instruction set. Further, when unimplemented instruction 1 (902A) through unimplemented instruction N (902B) are the same unimplemented instruction, emulation instruction(s) 1 (908A) through emulation instruction(s) N (908B) may be the same emulation instruction(s).

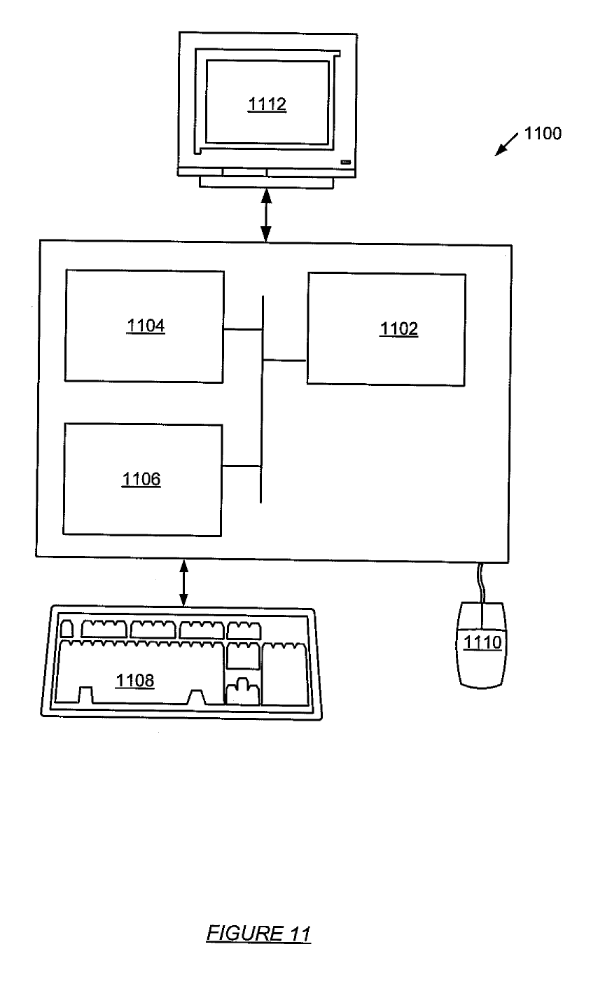

FIG. 10 shows an example of replacing identified instruction(s) with emulation code in accordance with one or more embodiments of the invention. In the example of FIG. 10, the identified instruction(s) are replaced with transfer instruction(s) that redirect the execution of the binary to emulation instructions.

The original binary (1000) is generated by a compiler (not shown) from source code. The original binary (1000) includes a number of unimplemented instruction(s), i.e., unimplemented instruction 1 (1002A) through unimplemented instruction N (1002B). For purposes of this example, unimplemented instruction 1 (1002A) through unimplemented instruction N (1002B) are the same instruction. The binary transformer (1004) identifies each of unimplemented instruction 1 (1002A) through unimplemented instruction N (1002B)) based on input from a user. For example, the user specifies that all occurrences of a specific unimplemented instruction should be identified and replaced in the original binary (1000).

Next, the binary transformer (1004) adds emulation instruction(s) (1006) to the updated binary (1006). The emulation instruction(s) (1006) are accessible in the updated binary as a routine (not shown). Further, the emulation instruction(s) are obtained from a transformer data source (1012). The transformer data source (1012) includes emulation instruction(s) one or more unimplemented instructions.

The binary transformer (1004) then replaces each of unimplemented instruction 1 (1002A) through unimplemented instruction N (1002B) with transfer instruction 1 (1008A) through transfer instruction N (1008B), respectively in the updated binary (1006). More specifically, the binary transformer (1004) replaces unimplemented instruction 1 (1002A) with transfer instruction 1 (1008A) and unimplemented instruction N (1002B) with transfer instruction N (1008B). Transfer instruction 1 (1008A) and transfer instruction N (1008B) direct execution of the updated binary to the emulation instruction(s) (1010).

Embodiments of the invention may be implemented on virtually any type of computer regardless of the platform being used. For example, as shown in FIG. 11, a networked computer system (1100) includes a processor (1102), associated memory (1104), a storage device (1106), and numerous other elements and functionalities typical of today's computers (not shown). The networked computer (1100) may also include input means, such as a keyboard (1108) and a mouse (1110), and output means, such as a monitor (1112). The networked computer system (1100) is connected to a local area network (LAN) or a wide area network (e.g., the Internet) (not shown) via a network interface connection (not shown). Those skilled in the art will appreciate that these input and output means may take other forms, now known or later developed. Further, those skilled in the art will appreciate that one or more elements of the aforementioned computer (1100) may be located at a remote location and connected to the other elements over a network.

Further, the embodiments of the invention may be implemented on a distributed system having a plurality of nodes, where each portion of the invention may be located on a different node within the distributed system. In one or more embodiments of the invention, the node may be a computer system. Alternatively, the node may be a processor with associated physical memory.

In one or more embodiments of the invention, software instructions to perform embodiments of the invention, when executed by a processor, may be stored on a computer readable medium such as a compact disc (CD), a diskette, a tape, a file, or any other computer readable storage device. Further, one or more embodiments of the invention may be implemented as an Application Programming Interface (API) executing on a computer system(s), where the API includes one or more software instructions.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for transforming a binary, comprising:
identifying an instruction in the binary, wherein the instruction is an unimplemented instruction of an instruction set of a processor;
replacing the instruction with emulation code, wherein execution of the emulation code emulates execution of the instruction; and
generating an updated binary including the emulation code.

2. The method of claim 1, wherein generating the updated binary comprises:
updating a plurality of memory address references in the binary in response to the replacing of the instruction.

3. The method of claim 1, wherein the emulation code comprises a plurality of emulation instructions that emulate the instruction.

4. The method of claim 1, wherein
the emulation code comprises a transfer instruction and a plurality of emulation instructions that emulate the instruction, and
replacing the instruction further comprises:
adding the plurality of emulation instructions to the updated binary; and
replacing the instruction with the transfer instruction.

5. The method of claim 1, wherein the emulation code comprises a software trap instruction, wherein the software trap instruction transfers execution of the binary to a plurality of emulation instructions specified by a user, wherein the plurality of instructions emulate the instruction.

6. The method of claim 1, further comprising:
retrieving the emulation code from a repository of emulation code.

7. The method of claim 1, wherein the emulation code is obtained using an application programming interface.

8. A computer system, comprising:
a processor;
a memory; and
instructions stored in memory for causing the computer system to:
identify an instruction in the binary, wherein the instruction is an unimplemented instruction of an instruction set of a target processor;
replace the instruction with emulation code, wherein execution of the emulation code emulates execution of the instruction; and
generate an updated binary including the emulation code.

9. The computer system of claim 8, wherein the instructions to generate the updated binary further comprise instructions to:
update a plurality of memory address references in the binary in response to the replacing of the instruction.

10. The computer system of claim 8, wherein the emulation code comprises a plurality of emulation instructions that emulate the instruction.

11. The computer system of claim 8, wherein
the emulation code comprises a transfer instruction and a plurality of emulation instructions that emulate the instruction, and
the instructions to replace the instruction further comprise instructions to:
add the plurality of emulation instructions to the updated binary; and
replace the instruction with the transfer instruction.

12. The computer system of claim 8, wherein the emulation code comprises a software trap instruction, wherein the software trap instruction transfers execution of the binary to a plurality of emulation instructions specified by a user, wherein the plurality of instructions emulate the instruction.

13. The computer system of claim 8, wherein the instructions to replace the instruction further comprise instructions to retrieve the emulation code from a repository of emulation code.

14. The computer system of claim 8, wherein the emulation code is obtained using an application programming interface.

15. A computer readable medium, embodying instructions executable by the computer to perform method steps for request processing, the instructions comprising functionality to:
identify an instruction in the binary, wherein the instruction is an unimplemented instruction of an instruction set of a processor;
replace the instruction with emulation code, wherein execution of the emulation code emulates execution of the instruction; and
generate an updated binary including the emulation code.

16. The computer readable medium of claim 15, wherein the instructions to generate the updated binary further comprise functionality to:
update a plurality of memory address references in the binary in response to the replacing of the instruction.

17. The computer readable medium of claim 15, wherein the emulation code comprises a plurality of emulation instructions that emulate the instruction.

18. The computer readable medium of claim 15, wherein
the emulation code comprises a transfer instruction and a plurality of emulation instructions that emulate the instruction, and
the instructions to replace the instruction further comprise functionality to:
add the plurality of emulation instructions to the updated binary; and
replace the instruction with the transfer instruction.

19. The computer readable medium of claim 15, wherein the emulation code comprises a software trap instruction, wherein the software trap instruction transfers execution of the binary to a plurality of emulation instructions specified by a user, wherein the plurality of emulation instructions emulate the instruction.

20. The computer readable medium of claim 15, the instructions further comprising functionality to:
retrieve the emulation code from a repository of emulation code.
